(19) United States
(12) Patent Application Publication
(10) Pub. No.: US 2008/0149185 A1
(43) Pub. Date: Jun. 26, 2008

(54) METHOD FOR PRODUCING A DEVICE FOR CONTROLLING THE FLOW OF A GASEOUS OR LIQUID MEDIUM

(76) Inventors: Gerhard Walter, Dettingen (DE); Marcus Lohr, Esslingen (DE); Bjoern Krieger, Altbach (DE)

Correspondence Address: Striker, Striker & Stenby, 103 East Neck Road, Huntington, NY, 11743, US

(21) Appl. No.: 11/865,136

(22) Filed: Oct. 1, 2007

(30) Foreign Application Priority Data
Dec. 22, 2006 (DE) 10 2006 060 876.3

(51) Int. Cl. F16K 17/36

(52) U.S. Cl. 137/38

(57) ABSTRACT

For producing a device for controlling the flow of a medium, having a housing and a flap supported pivotably in it between a closing position and an open position, which flap in its closing position rests with its peripheral region on stop faces of the housing that are present on both sides of the longitudinal axis, to create tightness in the closing position in later operation, the flap is subjected to a force which is selected, taking into account the material comprising the stop faces and the flap, such that the flap with its peripheral region rests on at least one stop face at least substantially with linear contact. The force can be selected such that the housing, in the region of at least one stop face, and/or the flap, in its peripheral region, is permanently deformed. The housing and the flap are of metal.

### CROSS-REFERENCE TO A RELATED APPLICATION

The invention described and claimed hereinbelow is also described in German Patent Application DE 10 2006 060 876.3 filed on Dec. 22, 2006. This German Patent Application, whose subject matter is incorporated here by reference, provides the basis for a claim of priority of invention under 35 U.S.C. 119(a)-(d).

### BACKGROUND OF THE INVENTION

The invention relates to a method for producing a device for controlling the flow of a gaseous or liquid medium.

In known methods of this type (German Patent Disclosure DE 196 03 547 A1), a plastic flap is heated by means of supplied energy in its closing position and subjected to a closing force such that the peripheral regions of the flap that rest on stop faces of the housing are plastically deformed and thus adapted to the stop faces of the housing. Such flaps, made of relatively soft plastic material, do not meet the requirements for the intended use of the device. Because of these flaps, the service life of such devices is relatively short. Since it cannot be precluded that contaminants or similar particles will be entrained in the medium, these entrained particles can accumulate, in the closing position of the flap, between the peripheral region of the flap and the stop faces of the housing and press into the material comprising the flap or in some other way damage the peripheral region of the flap and involve the stop faces of the housing as well, with the result that relatively quickly, a lack of tightness in the closing position of the flap ensues, resulting in relatively major leakage.

It is also disadvantageous that producing such a device involves difficulties; this is because upon heating and deforming of the plastic flap, care must be taken in its peripheral region that this peripheral region will not flow entirely away, in which case even upon production, the result is a flap that is unusable. The known method described is therefore unsuitable for the production of such devices, especially valves, of which a long service and durability and at the same an extremely tightly closing flap in the closing position are expected, and all of this is expected to be reliable over a long period of operation.

Flap valves with a valve that comes to a stop on one side are known. They are disadvantageous on account of major leakage. Other known flap valves have an axial stop on both sides. Their disadvantages are either major leakage because of component and assembly tolerances, or very high production costs because of the high precision required. Flap valves with a piston ring for sealing are also known. The disadvantage of these valves are the high opening forces required to overcome the frictional force, and high production costs.

### SUMMARY OF THE INVENTION

It is therefore an object of the invention is to create a method of the type defined at the outset which in a simple, economical way makes it possible to produce a valvelike device with a flap that closes extremely tightly even over a long service life.

In keeping with these objects and with others which will become apparent hereinafter, one feature of the present invention resides, briefly stated, in a method for producing a device for controlling a flow of a gaseous or liquid medium, having a housing and a flap pivotally supported in the housing about a longitudinal axis between a closing position in which it rests with its peripheral region on stop faces of the housing on both sides of the longitudinal axis and preferably substantially in a semi-circle and an open position, the method comprising the steps of acting upon the flap by a force to create tightness in the closing position; and selecting the force, taking into account a strength of a material forming the stop faces on the housing and a material of the flap with its peripheral region, such that the flap with its peripheral region rests at least substantially with linear contact on at least one of the stop faces of the housing.

The method according to the invention makes it possible, with a simple, economical procedure, to produce a device that in operation as intended closes extremely tightly whenever the flap is in the closing position. This is also assured without change over quite a long service life of the device. Between the flap and the housing, there is essentially a linear contact. In the embodiment as an exhaust gas recirculation valve, this has the great advantage that a tendency to stick in the closing state because of exhaust gas condensates is avoided. The virtually complete tightness attainable in the closing position of the flap means that in the closing position, there is either no leakage or only extremely small negligible leakage.

The method has the advantage that in the event of a plastic deformation of the metal housing, at least in the region of a preferably oblique inclined face, and/or of the flap, in its peripheral region, tolerances both for the flap and in the region of the respective stop face of the housing, for instance on the surface, are compensated for. It is also advantageous that a plastic deformation of the housing and/or of the flap occurs only a single time, and thus the respective stop face of the housing and the associated peripheral region of the flap and hence the cooperating contacting surfaces are pressed against one another. The invention thus makes possible the adjustment or even calibration of compensation for tolerances. As a result, there is no need for especially stringent demands in terms of tolerances in the production of the flap and of the stop faces of the housing, since these tolerances are automatically compensated for by the one-time plastic deformation of the housing and/or of the flap. This too results in a cost reduction in the production of both the housing and the flap.

A device produced by the method of the invention moreover has the advantage that depending on given conditions, the closing force required, in operation as intended, to bring about and maintain the closing position of the flap can be reduced, compared to conventional devices, or as needed even be selected to be greater than the allowable closing force in the known valve of DE 196 03 547 A1, a force that in this known valve, because of the plastic material of the flap, can be only slight so as to avoid permanent deformation.

The invention also relates to a device, which is produced by the method of the invention. The device has further inventive characteristics and features pertaining to it.

Further details and advantages of the invention are explained in the ensuing description. The full wording of the claims is not repeated above, solely to avoid unnecessary repetition, but instead is merely referred to with references to the claims; nevertheless, all these claims characteristics must be considered here to be expressly disclosed as essential to the invention. All the characteristics mentioned above and in the ensuing description as well as all the characteristics that can be learned solely from the drawings are additional components of the invention even if they are not especially emphasized and in particular even if they are not mentioned in the claims.

### BRIEF DESCRIPTION OF THE DRAWINGS

FIG. 1 is a schematic perspective view of a housing of a device for controlling the flow of a gaseous or liquid medium, without a control member in the form of a flap, in a first exemplary embodiment;

FIG. 2 is a schematic section taken along the line II-II in FIG. 1;

FIG. 3 is a schematic section, approximately corresponding to that of FIG. 2, on a larger scale and in a phase during the production of a calibrated tolerance compensation;

FIG. 4 is a schematic section, corresponding to that in FIG. 3, after the completion of the calibrated tolerance compensation;

FIG. 5 is an enlarged detail marked V in FIG. 4;

FIG. 6 is a schematic section, approximately corresponding to that in FIG. 3, of part of a device in a second exemplary embodiment, in a phase during the adjustment of the tolerance compensation; and

FIG. 7 is a schematic section, corresponding approximately to that of FIG. 6, after the completion of the tolerance compensation.

### DESCRIPTION OF THE PREFERRED EMBODIMENTS

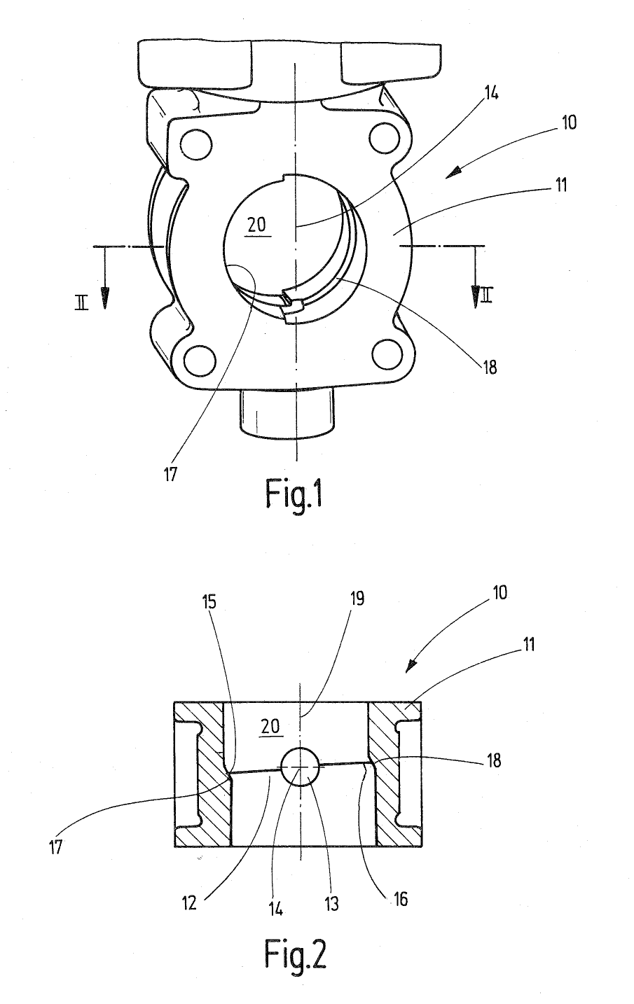

In FIGS. 1 through 5, a first exemplary embodiment is shown of a device 10 for controlling the flow of a gaseous or liquid medium. The device 10 is an exhaust gas recirculation valve, for example. The device 10 has a housing 11 and in it a valve closure member, embodied here as a flap 12. The flap 12 is secured in or on a flap shaft 13 and is supported pivotably and actuatably about the longitudinal axis 14 between an open position and a closing position, the latter shown in FIG. 2. The flap 12 in the exemplary embodiment shown is approximately circular in shape, but the circumferential contour of the flap 12 may also be designed differently. In the closing position in FIG. 2, the flap 12 rests with peripheral regions 15, 16, present on both sides of the longitudinal axis 14, on associated stop faces 17 and 18, respectively, of the housing 11 that in adaptation to the contour of the flap 12 extend approximately semicircularly. The housing 11 includes a central passage 20 in the form of a bore, which can be variably opened and closed by the flap 12, providing control accordingly of the flow through it of the medium. The passage 20 is essentially cylindrical, and its longitudinal center axis extends transversely, in particular approximately perpendicularly, to the longitudinal axis 14 and is therefore hereinafter called the transverse axis 19. The stop faces 17, 18 extend on both sides of the transverse axis 19 and extend approximately semicircularly around it.

For creating the later tightness of the device 10 in operation when the flap 12 is in the closing position, a special, calibrated tolerance compensation can be performed between the peripheral region s 15, 16 on the one hand and the associated stop faces 17, 18 on the other. The flap 12 can be subjected in its peripheral region 15, 16 to a force that is above the limit of elasticity, taking into account the strength of the material that forms the stop faces 17, 18 of the housing and of the material of the flap 12, in such a way that a plastic or in other words permanent deformation of the housing 11 and/or of the flap 12 occurs. Instead of that, the force may also be selected such that the flap 12 rests with its peripheral region 15, 16 essentially with linear contact on at least one stop face 17, 18 of the housing 11. If a plastic deformation in accordance with the first exemplary embodiment is sought, then this force is selected such that the housing 11, in the region of at least one of the stop faces 17, 18, and/or the flap 12, in its peripheral region 15, 16, is deformed permanently and such that the flap 12, with its respective peripheral region 15, 16, cuts into the associated at least one stop face 17, 18, and/or the peripheral region 15, 16 of the flap 12 is deformed in adaptation to at least one stop face 17, 18.

In the first exemplary embodiment shown in FIGS. 1 through 5, the force that is exerted a single time on the flap 12 to create tightness in the closing position of the flap is exerted in the pivoting direction of the flap 12 about its longitudinal axis 14, and hence in the closing direction of the flap 12. The peripheral region 15 of the flap 12, if its material is designed to be harder than the housing 11, can dig into the stop face 17, while the other peripheral region 16 of the flap 12 digs into the associated other stop face 18. In addition, or instead, the peripheral region 15, 16 of the flap 12 may become deformed. Instead of bringing about a plastic deformation, it is also possible to create merely a linear contact between the flap 12 and the housing 11. Further details will be explained hereinafter.

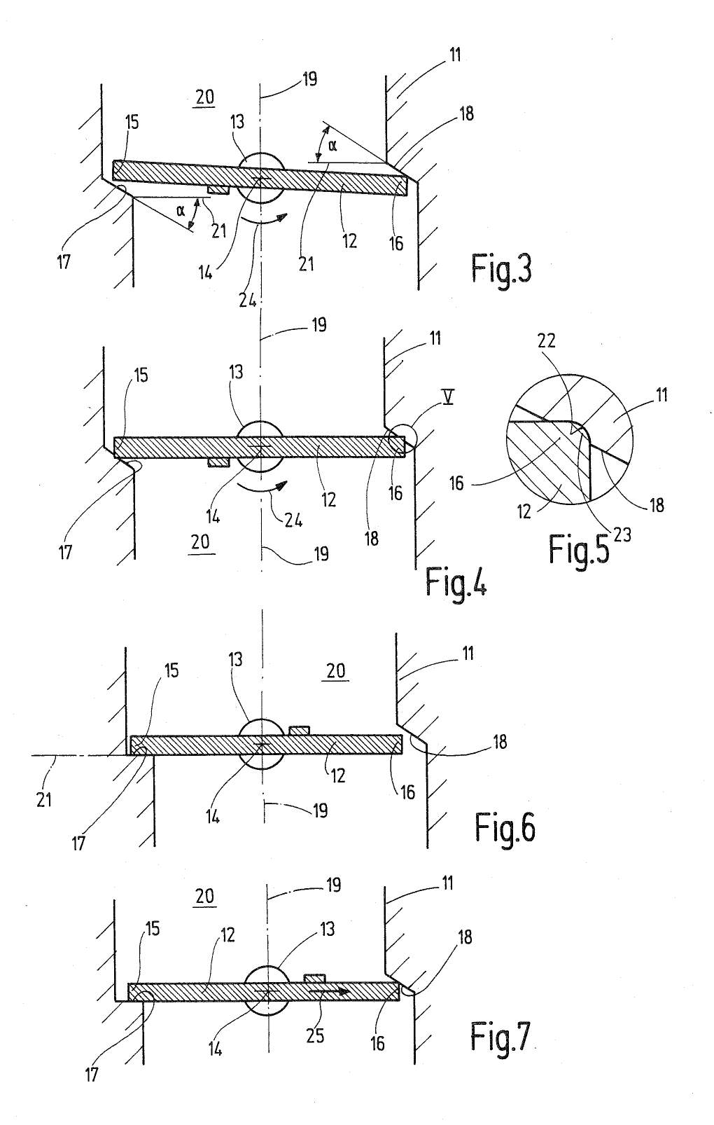

It can be seen that the housing 11, on both sides of the longitudinal axis 14 of the flap 12, has preferably approximately semicircularly extending stop faces 17, 18; the special feature of these faces is that both stop faces 17 and 18 are oriented obliquely with respect to a plane 21, which extends approximately perpendicularly to the transverse axis 19 of the housing and thus radially, and are embodied as respective inclined faces. The angle of inclination a of the inclined faces is shown only in FIG. 3. It amounts to between approximately 5° and 35° and may preferably be approximately 16.50. The inclination on both sides has the particular advantage that no recirculation zones and dead water zones occur in the flow course of the medium, and hence less dirt is deposited.

It can be appreciated that both stop faces 17, 18 of the housing 11 are offset from one another in the direction of the transverse axis 19 of the housing. In the final state after the calibrated tolerance compensation, each stop face 17, 18, on its face toward the respective peripheral region 15 and 16, has a groove 22 of approximately V-shaped cross section, which can be seen in the enlarged view in FIG. 5. The groove 22 corresponds at least essentially to the cross-sectional shape and cross-sectional size of the region 23, shown enlarged in FIG. 5, of the associated peripheral region 16 of the flap 12.

Both the housing 11, or at least the stop faces 17, 18 of the housing, which here are in one piece with the housing 11 but may instead be formed by separate inlay parts, and the flap 12, or at least its peripheral region 15 and 16, which in the exemplary embodiment shown is likewise in one piece with the rest of the flap 12, but instead may also be formed by a separate annular part, are formed from metal material. For instance, the stop faces 17, 18 are formed of one metal material, which has a lesser strength than the metal material from which the flap 12, or at least its peripheral region 15, 16, is formed. The ratios may also be reversed. The metal material of the flap 12 may have approximately twice the strength of the metal material of the stop faces 17, 18 of the housing. Thus the strength of the metal material of the flap 12, or at least its peripheral region 15, 16, may amount to between approximately 450 N/mm² and 750 N/mm², and preferably approximately 700 N/mm². The strength of the metal material of the housing 11, or at least of the stop faces 17, 18 of the housing, may be selected such that it amounts to between approximately 200 N/mm² and 400 N/mm², preferably for instance 350 N/mm². The strength ratios of the flap 12 and the housing 11 may also be reversed.

The housing 11, or at least its stop faces 17, 18, are formed from a lightweight metal material, such as aluminum, an AlSiMg alloy, or the like. Cast iron, such as gray cast iron, can also be considered. The flap 12, which in comparison to the stop faces 17, 18 has considerably greater strength, is formed of steel, such as special steel, at least in its peripheral region 15, 16.

A device 10 of the type described in the first exemplary embodiment is produced by the following method. First, the flap 12 is roughly centered relative to the flap shaft 13, and it is then solidly joined to the flap shaft 13. This is approximately the situation shown in FIG. 3. Next, with the aid of suitable means, the flap 12 is first pivoted about the longitudinal axis 14 so far that it rests with its respective peripheral region 15, 16 on the associated stop face 17, 18. From FIGS. 3 through 5 it can be seen that the peripheral region 15, 16 may have a terminal region, such as the region 23, which is designed as a sharp edge and as a result rests with approximately linear contact on the associated stop face 17, 18. Under some circumstances, this may suffice for calibration. However, to create tightness in later operation in the closing position, an additional force may also be exerted on the flap in its pivoting direction about the longitudinal axis 14. The exertion of this force in the pivoting direction may be accomplished by means of pressing members, not shown, which act on the respective halves of the flap to cause them to pivot in the direction of the arrow 24.

In its peripheral region 15, 16 associated with the respective oblique stop face 17, 18, the flap 12 can cut with a sharp edge into the inclined face in such a way that a groove 22 of at least essentially V-shaped cross section is cut into the inclined face. It may be advantageous, or at least is not precluded, that the sharp edge, on cutting a single time into the oblique stop face 17, 18, is plastically deformed at least slightly in adaptation to the cross-sectional shape and cross-sectional size of the cut-in groove 22. Instead or in addition, a plastic deformation of the flap 12 may also occur. The force exerted in the pivoting direction of the flap 12 indicated by the arrow 24 can, instead of being created with pressing members, also be created by application of a torque to the flap shaft 13. This method has the advantage that by plastic deformation of the stop faces 17, 18 of the housing and/or of the peripheral region 15, 16, both the tolerances of the flap 12 and also certain inaccuracies or uneven features, for instance, in the surface of the oblique stop faces 17, 18 of the housing 11 are compensated for, so that in a very simple way—even though the flap 12 and the housing 11 comprise a metal material—a reliably tight closing position of the flap 12 is assured in the later operation of the device 10, with no or only negligibly slight leakage.

The plastic deformation of the housing 11, at least of its stop faces 17, 18, and/or of the flap 12 also has the advantage that this occurs only a single time upon production, and thus the stop faces 17, 18 and the peripheral region 15, 16 of the flap are adapted very precisely to one another, so that later in the intended use, no additional forces have to be brought to bear to assure the tightness of the flap 12 in the closing position. In the production of both the housing 11 and the flap 12, stringent demands in terms of tolerances need not be made, since these tolerances are automatically compensated for by the one-time plastic deformation of the housing 11, in the region of the stop face 17, 18, and/or of the flap 12. As a result, the costs for producing the flap 12 and the housing 11 drop considerably.

In the second exemplary embodiment, shown in FIGS. 6 and 7, the housing 11 is designed such that only one of the two stop faces of the housing 11, that is, the stop face 18 shown on the right in FIGS. 6 and 7, is oriented obliquely and embodied as an inclined face, as was the case for both stop faces 17, 18 in the first exemplary embodiment. Conversely, the other stop face 17 of the housing is designed rectilinearly, or in other words in plane fashion and extends approximately within the plane 21 that is oriented approximately perpendicularly to the transverse axis 19 of the housing and extends radially. A tolerance compensation is created in the following way.

The flap 12 is first subjected to a defined closing force, approximately as in FIG. 6 on the flap half located on the left there, and pressed with its peripheral region 15 onto the associated rectilinearly extending stop face 17 of the housing 11. Then, during the action of this pressing force, the flap is pressed to the right in a rectilinear direction in FIGS. 6 and 7, by means of a force acting horizontally and bringing about the tolerance compensation, against the other, obliquely oriented stop face 18 embodied as an inclined face, so that a linear contact is attained. After that, the flap 12 is fixed on or in the flap shaft 13, which can be done by welding, especially laser welding. The force that is exerted a single time on the flap 12 to create tightness of the flap in the closing position thus acts substantially in the horizontal, radial direction indicated by arrow 25, and this force is operative during the pressing of the flap half on the left in FIGS. 6 and 7, having the peripheral region 15, against the associated stop face 17.

In this rectilinear displacement of the flap 12, the flap 12 with its peripheral region 16, which may have a sharp edge, is thrust against the associated stop face 18, which is oriented obliquely and embodied as an inclined face. Depending on the magnitude of this radial force exerted, the result is either only pressing of the sharp-edged peripheral region 16 against the stop face 18, or else cutting in, as in the first exemplary embodiment, with plastic deformation of the stop face 18.

It will be understood that each of the elements described above, or two or more together, may also find a useful application in other types of methods and constructions differing from the type described above.

While the invention has been illustrated and described as embodied in a method for producing a device for controlling the flow of a gaseous or liquid medium, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for producing a device for controlling a flow of a gaseous or liquid medium, having a housing and a flap pivotally supported in the housing about a longitudinal axis between a closing position in which it rests with its peripheral agent on stop faces of the housing on both sides of the longitudinal axis and preferably substantially in a semi-circle and an open position, the method comprising the steps of acting upon the flap by a force to create tightness in the closing position; and selecting the force, taking into account a strength of a material forming the stop faces on the housing and a material of the flap, on its peripheral region, such that the flap with its peripheral region rests at least substantially with linear contact or at least one of the stop faces of the housing.

2. A method as defined in claim 1, wherein said selecting includes selecting the force such that an element selected from the group consisting of the housing in a region of at least one of the stop faces, the flap at its peripheral region, and both, is deformed permanently and in a manner selected from the group such that the flap with its peripheral region cuts into the at least one stop face, the peripheral region of the flap is deformed in adaptation to at least one stop face, and both.

3. A method as defined in claim 1, further comprising dimensioning the force as greater than a closing force of the flap required for the tightness in the closing position.

4. A method as defined in claim 1, and further comprising forming an element selected from the group consisting of the housing, at least the stop face of the housing, the flap , and the peripheral region of the flap, of metal material.

5. A method as defined in claim 4; and further comprising selecting a strength of the metal material for one element selected from the group consisting of the flap and the housing greater than a strength of the metal material of the other element selected from the group consisting of the flap and the housing.

6. A method as defined in claim 5, wherein said selecting includes selecting the metal material of one of the elements to have substantially twice a strength of the metal material of the other element.

7. A method as defined in claim 6, wherein said selecting includes selecting the metal material of the peripheral region of the flap to be substantially twice the strength of the metal material of the stop faces of the housing, or vice versa.

8. A method as defined in claim 4, and further comprising selecting a strength of the metal material of an element selected from the group consisting of the flap and its peripheral region between substantially 450 N/mm² and 750 N/mm².

9. A method as defined in claim 8, wherein said selecting includes selecting the strength of the material of the element selected from the group consisting of the flap and its peripheral region to be substantially 700 N/mm².

10. A method as defined in claim 4; and further comprising selecting a strength of the metal material of an element selected from the group consisting of the housing and at least the stop faces of the housing between substantially 200 N/mm² and 400 N/mm².

11. A method as defined in claim 10, wherein said selecting includes selecting the strength of the metal material selected from the group consisting of the housing and the stop faces substantially 350N/mm².

12. A method as defined in claim 1, further comprising forming an element selected from the group consisting of the housing and at least one of the stop faces of the housing of a material selected from the group consisting of a light weight metal material and a cast part.

13. A method as defined in claim 12, wherein said light weight metal material is a material selected from the group consisting of aluminum and AlSiMg, and said cast part comprises gray cast iron.

14. A method as defined in claim 1; and further comprising forming an element selected from the group consisting of the flap and at least its peripheral region from steel.

15. A method as defined in claim 1; and further comprising orienting at least one stop face of the housing obliquely relative to a radial plane extending perpendicularly to a traverse axis of the housing and configured as an inclined face, on which the flap in its closing position with an associated peripheral region, rests at least substantially with linear contact.

16. A method as defined in claim 15, and further comprising selecting an angle inclination of the inclined face relative to the radial plane between substantially 5° and 35°.

17. A method as defined in claim 16, wherein said selecting the angle of inclination includes selecting the inclination of the inclined face relative to the radial plane to be substantially 16.5°.

18. A method as defined in claim 1; and further comprising cutting by means of the flap a groove of substantially V-shaped cross-section into at least one stop face.

19. A method as defined in claim 18, wherein said cutting includes cutting the groove into the at least one stop face which is configured as an inclined stop face.

20. A method as defined in claim 19, wherein said cutting includes cutting the flap, at its peripheral region that is associated with the at least one stop face, with a sharp edge into the inclined stop face.

21. A method as defined in claim 20, further comprising deforming the sharp edge, in the one-time cutting into the stop face, plastically in adaptation to a cross-sectional shape and a cross-sectional size of the groove.

22. A method as defined in claim 1; and further comprising offsetting the stop faces of the housing from one another in a direction of a transverse axis of the housing.

23. A method as defined in claim 1; and further comprising orienting the stop faces of the housing obliquely and configuring the stop faces as inclined faces.

24. A method as defined in claim 23; and further comprising selecting an angle of inclination of the stop faces of the housing of a same size.

25. A method as defined in claim 1, and further comprising exerting the force upon the flap a single time for creating tightness in the closing position of the flap in a pivoting direction of the flap about the longitudinal axis and thus in the closing position of the flap.

26. A method as defined in claim 1; and further comprising orienting one of the stop faces of the housing obliquely and configuring it as an inclined face, and extending the other of the stop faces rectilinearly and substantially within a radial plane oriented substantially perpendicularly to a transverse axis of the housing.

27. A method as defined in claim 26; and further comprising exerting the force on the flap a single time for creating tightness in the closing position of the flap in a radial direction such that the flap is thrust on the rectilinearly extending stop face of the housing in a direction of the obliquely oriented stop face embodied as an inclined face and with its peripheral region associated with the obliquely oriented stop face striking the inclined face.

28. A method as defined in claim 27, wherein said striking the inclined face includes cutting into the inclined face of the housing.

29. A method as defined in claim 1; and further comprising, before exerting the force for creating tightness in the closing position, roughly centering the flap relative to a flap shaft and then solidly joining to the flap shaft.

30. A method as defined in claim 1; and further comprising exerting the force in a pivoting direction of the flap by pressing members that act on halves of the flap.

31. A method as defined in claim 1; and further comprising exerting the force in a pivoting direction of the flap by application of a torque to a flap shaft.

32. A method as defined in claim 1; and further comprising, before exerting the force to create tightness in the closing position, acting upon the flap by a defined closing force acting on one flap half and, under the closing force, pressing with an associated peripheral region onto one of the stop faces of the housing which is an associated stop face and extend rectilinearly, and then during a direction of a pressing force, pressing the flap by the force in a rectilinear direction against the other of the stop faces which is oriented obliquely and configured as an inclined face.

33. A method as defined in claim 32; and further comprising effecting the exerting of the pressing force and of the force prior to a fixation of the flap with a flap shaft selected from the group consisting of fixation of the flap on the flap shaft and fixation of the flap in the flap shaft.

34. A method as defined in claim 33; and further comprising, after the exerting of the pressing force and of the force, solidly joining the flap to the flap shaft.

35. A method as defined in claim 34; and further comprising performing the joining by a process selected from the group consisting of a welding and a laser welding.

36. A method as defined in claim 35, wherein said joining includes welding of the flap to the flap shaft.

37. A method as defined in claim 35, wherein said joining includes laser welding of the flap to the flap shaft.

38. A device for controlling of a gaseous or liquid medium, produced by a method comprising the steps of acting upon a flap by a force to create tightness in a closing position in which the flap rests with its peripheral region on step faces of a housing, and selecting the force, taking into account a strength of a material forming the stop faces on the housing and a material of the flap, on its peripheral region, such that the flap with its peripheral region rests at least substantially with linear contact on at least one of the stop faces of the housing.

39. A device as defined in claim 37, wherein the stop faces of the housing located on both sides of the longitudinal axis of the flap are substantially semi-circularly extending stop faces, and wherein at least one of the faces is oriented obliquely relative to a radial plane extending substantially perpendicularly to a transverse axis of the housing and is configured as an inclined face.

40. A device as defined in claim 38, wherein an angle of inclination of the inclined face relative to the radial plane is substantially between 5° and 35°.

41. A device as defined in claim 40, wherein the angle of inclination of the inclined face relative to the radial plane is substantially 16.5°.

42. A device as defined in claim 38, wherein the stop faces are both oriented obliquely and configured as inclined faces.

43. A device as defined in claim 38, wherein the stop faces of said housing are offset from one another in a direction of a transverse axis of said housing.

44. A device as defined in claim 39, wherein at least one of the faces is inclined and has a groove that is substantially V-shaped in cross-section, said groove corresponding to a cross-sectional shape and a cross-sectional size of the peripheral region of the flap associated with the inclined face.

45. A device as defined in claim 38, wherein an element selected from the group consisting of said housing, said stop faces of said housing, said flap, said peripheral region of said flap, is composed of metal material.

46. A device as defined in claim 45, wherein a strength of the metal material of one element selected from the group consisting of said flap and said stop faces at said housing is greater than a strength of the other element selected from the group consisting of said flap and said stop faces of said housing.

47. A device as defined in claim 45, wherein the metal material of one element selected from the group consisting of said flap and said stop faces of said housing has substantially twice a strength of the other element selected from the group consisting of said flap and said stop faces of the housing.

48. A device as defined in claim 45, wherein a strength of the metal material of the peripheral region of the flap is twice the strength of the metal material of the stop faces of the housing.

49. A device as defined in claim 45, wherein the strength of the metal material of an element selected from the group consisting of the flap and its peripheral region is substantially between 450 N/mm² and 750 N/mm².

50. A device as defined in claim 49, wherein the strength of the metal material of the element selected from the group consisting of the flap and its peripheral region is substantially 700 N/mm².

51. A device as defined in claim 45, wherein a strength of the metal material of an element selected from the group consisting of said housing and said stop faces of said housing is between substantially 200 N/mm² and 400 N/mm².

52. A device as defined in claim 51, wherein the strength of the metal material of said element selected from the group consisting of said housing and said at stop faces is substantially 350 N/mm².

53. A device as defined in claim 38, wherein an element selected from the group consisting of said housing and said stop faces on said housing is composed of a material selected from the group consisting of a light weight metal material and a cast part.

54. A device as defined in claim 52, wherein said light weight metal material is a material selected from the group consisting of aluminum and an AlSiMg alloy, while said cast part comprises gray cast iron.

54. A device as defined in claim 38, wherein an element selected from the group consisting of the flap and its peripheral region is composed of steel.
